(19) United States
(12) Patent Application Publication
(10) Pub. No.: US 2010/0146277 A1
(43) Pub. Date: Jun. 10, 2010

(54) SEMICONDUCTOR INTEGRATED CIRCUIT

(75) Inventors: Yoshinori Mochizuki, Sagamihara (JP); Harumi Morino, Yokohama (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/633,489

(22) Filed: Dec. 8, 2009

(30) Foreign Application Priority Data
Dec. 9, 2008 (JP) 2008-312939

(51) Int. Cl. H04L 9/32; H04L 9/08; H04L 9/00

(52) U.S. Cl. 713/169; 380/270; 380/279

(57) ABSTRACT

The present invention aims to avoid a needless increase in cable wiring when a cipher key is shared between other electronic devices upon encrypted wireless communication. A semiconductor integrated circuit comprises a wireless communication control circuit for the encrypted wireless communication, a processing unit for managing the cipher key, and a power line communication circuit. The semiconductor integrated circuit is operated by a power supply voltage supplied externally to the power line communication circuit via a power line. The power line communication circuit is coupled to other electronic devices via the power line. The wireless communication control circuit communicates with the other electronic devices by the encrypted wireless communication. Before the semiconductor integrated circuit performs encrypted wireless communication with other electronic devices using the wireless communication control circuit, the semiconductor integrated circuit supplies information about the cipher key to other electronic devices via the power line communication circuit.

### CLAIM OF PRIORITY

The present invention claims priority from Japanese patent application JP 2008-312939, filed on Dec. 9, 2008, the content of which is hereby incorporated by reference into this application.

### FIELD OF THE INVENTION

The present invention relates to a semiconductor integrated circuit, and particularly to a technology beneficial to avoid a needless increase in cable wiring when a cipher key for an encrypted communication is shared between other electronic devices upon execution of wireless communication that adopts the encrypted communication.

### BACKGROUND OF THE INVENTION

Wireless communication free of the need for cables is being recently used in various scenes. An ultra wide band (UWB) communication that enables a high-speed communication of several hundreds of Mbps using a wide band of several GHz widths has been started to garner attention in recent years in particular. The FCC (Federal Communications Commission) has allocated a frequency range of 3.1 GHz to 10.6 GHz for the use of the ultra wide band (UWB) communication on February 2002.

According to the multi-band OFDM alliance (MBOA) for the ultra wide band (UWB) communication, a used frequency range of 3 GHz to 10 GHz is divided into a large number of bands of 528 MHz and OFDM is used in the individual bands to transfer data at a high rate of 480 Mb/s. Incidentally, OFDM is an abbreviation of Orthogonal Frequency Division Multiplexing.

On the other hand, an international standard that defines an ultra wide band (UWB) physical layer (PHY) and a media access control (MAC) sublayer for a high-speed and short-range wireless network, which supports a data rate up to 480 Mb/s and utilizes a spectrum of 3100 MHz to 10600 MHz, has been described in the following non-patent document 1.

On the other hand, the use of power line communication (PLC) has been permitted with being limited to indoor use in Japan in accordance with the revisions to the Radio Law and related ministerial ordinances on October 2006. The power line communication (PLC) is one wherein a power line is utilized as a communication path by superimposing a high-frequency signal on an indoor power line, thereby enabling high-speed communication.

The following non-patent document 2 has described that a complete node for power line communication (PLC) is implemented on a single chip. Architecture for the implementation of the complete node for the power line communication (PLC) by a system on-chip includes a microcontroller, a media access controller (MAC) and a modem based on a power line media standard. A power line interface of the modem includes a transformer coupled to a power line, a transmitting low-pass filter coupled to the transformer, and an analog-side A/D converter and a quantizer for reception. A digital logic of the modem includes a digital-side A/D converter coupled to the quantizer for reception, and a D/A converter and a logic unit coupled to the transmitting low-pass filter.

Further, a PLC network device equipped with a PLC module for performing power line communication and a wireless LAN module for performing wireless communication has been described in the following patent document 1. A PLC communication equality detection circuit detects the communication quality of the PCL module. A wireless communication quality detection circuit detects the communication quality of the wireless LAN module. A control unit performs transmission/reception of data by the wireless LAN module in response to low quality information outputted from the PLC communication quality detection circuit.

A power line communication/ultra wide band communication (PLC/UWB) module capable of utilizing power line communication (PLC) and ultra wide band communication (UWB) in combination and of being disposed inside a building has been described in the following patent document 2. The PLC/UWB module converts a power line signal sent from a server to an ultra wideband signal and broadcasts the ultra wideband signal to a wireless electronic device. Encrypting the power line communication signal and/or ultra wideband signal has been described to enhance safety.

### [Non-Patent Document 1]

Standard ECMA-368 2nd Edition/December 2007, “High Rate Ultra Wideband PHY and MAX Standard”, http://www.ecma-international.org/publications/files/ECMA-ST/ECMA-368.pdf[retrieval on Jun. 20, 2008]

### [Non-Patent Document 2]

A. Sanz et al, “A Complete Node for Power Line Communications in Single chip”, 2005 International Symposium on Power Line Communications and its Applications, 6-8 Apr. 2005, PP. 285-289.

### [Patent Document 1]

Japanese Unexamined Patent Publication No. 2008-228158

### [Patent Document 2]

Japanese Unexamined Patent Application Publication (Translation of PCT Application) No. 2007-504711

### SUMMARY OF THE INVENTION

According to the international standard related to the ultra wide band (UWB) communication described in the non-patent document 1, communication data is encrypted to prevent eavesdropping and leakage of the communication data, and a 4-way handshake process is performed to establish a safe relationship with pair-wise temporal keys (PTKs) between two devices for the purpose of encryption. The two devices use a shared master key to establish the safe relationship. A 4-way handshake mechanism makes it possible to use a shared master key for establishing new pair-wise temporal keys (PTKs) used to protect frame conversion between two devices and for authenticating the mutual identity of the two devices.

Only when it is determined that one device shares a master key with the other device, one device starts a 4-way handshake with the other device. The master key shared during the 4-way handshake is specified by a master key identifier (MKID) without being exposed.

Prior to the present invention, the present inventors et al. have been involved in the study/development of a system LSI (Large Scale Integrated circuit) capable of performing ultra wide band (UWB) communication with various electronic devices each mounted in a vehicle.

As an electronic device mounted in a vehicle, a back monitor for signal-processing a video signal of a back camera disposed in the rear of a vehicle body for ease of driving to thereby display it on an indication display lying in front of a driving seat has recently been in widespread use. As the indication display for the back monitor, an indication display of a car navigation system is used. The car navigation system has not only an original function that driving geographical information is displayed for a driver but also a multimedia function that the music of a music CD is reproduced from each speaker mounted in the vehicle or an image of a DVD is reproduced from the indication display mounted in the vehicle. A cellular phone terminal or a portable electronic device brought in the vehicle is coupled to a USB slot disposed in the vehicle so that the music of a non-volatile memory built in the cellular phone terminal or the portable electronic device is transferred from the USB slot to the car navigation system. The music transferred to the car navigation system is reproduced from speakers mounted in the vehicle. Incidentally, USB is an abbreviation of Universal Serial Bus.

Since a plurality of speakers and a plurality of indication displays are mounted at the driver and rear seats in the vehicle in such a case, cable wiring becomes cumbersome at the time that the car navigation system is coupled to the speakers, indication displays, back camera and USB slot within the vehicle. Thus, coupling between the various electronic devices by the cable wiring is not performed, namely, coupling by ultra wide band (UWB) communication free of the need for the cable wiring becomes effective.

With such a background, the present inventors et al. were involved in the study/development of the system LSI capable of ultra wide band (UWB) communication with the in-vehicle electronic devices prior to the present invention. During the study/development, the encrypted communication defined in the international standard has been adopted even to prevent crosstalk produced upon ultra wide band (UWB) communication between a plurality of vehicles close to one another. Upon encryption of the UWB communication between the electronic devices mounted in the vehicle, there is a need to share a master key between two devices that perform the UWB communication.

However, a problem that a method for sharing the master key between the two devices is not defined in the international standard has been revealed by the examinations of the present inventors et al. Although it is also assumed that the sharing of the master key is performed by another cable wiring different from the UWB communication, a problem that the adoption of the UWB communication becomes meaningless has also been revealed in this method.

The present invention has been made as the above result of examinations by the present inventors et al. prior to the present invention.

Thus, an object of the present invention is to provide a semiconductor integrated circuit capable of avoiding a needless increase in cable wiring when a cipher key for encrypted communication is shared between other electronic devices upon execution of wireless communication that adopts the encrypted communication.

The above and other objects and novel features of the present invention will become apparent from the description of the present specification and the accompanying drawings.

A representative one of the inventions disclosed in the present application will be explained in brief as follows:

A typical semiconductor integrated circuit (100) of the present invention comprises a wireless communication control circuit (116) for encrypted wireless communication, a processing unit (112) for managing a cipher key, and a power line communication circuit (114, 120). The semiconductor integrated circuit (100) is operated by a power supply voltage supplied externally to the power line communication circuit (114, 120) via a power line (122).

The power line communication circuit (114, 120) is couplable to other electronic devices (200A1, 200B1, . . . 200N1) via the power line (122).

The wireless communication control circuit (116) is capable of communicating with the other electronic devices (200A1, 200B1, . . . 200N1) by wireless communication which adopts the encrypted communication.

Prior to the execution of the wireless communication adopting the encrypted communication, with the other devices (200A1, 200B1, . . . 200N1) using the wireless communication control circuit (116), the semiconductor integrated circuit (100) becomes capable of supplying information about the cipher key for the encrypted communication to the other electronic devices (200A1, 200B1, . . . 200N1) via the power line communication circuit (114, 120) (refer to FIG. 1).

An advantage obtained by a representative one of the inventions disclosed in the present application will be explained in brief as follows: There can be provided a semiconductor integrated circuit capable of avoiding a needless increase in cable wiring when a cipher key for encrypted communication is shared between other electronic devices upon execution of wireless communication that adopts the encrypted communication.

### BRIEF DESCRIPTION OF THE DRAWINGS

FIG. 1 is a diagram showing a configuration of a semiconductor integrated circuit according to one embodiment of the present invention;

FIG. 2 is a diagram illustrating a method of causing an electronic device such as a car navigation system, having built the semiconductor integrated circuit corresponding to a system LSI shown in FIG. 1 therein to share a master key with other electronic devices mountable in a vehicle;

FIG. 3 is a diagram for describing mutual communications between two devices at UWB communication defined in an international standard;

FIG. 4 is a diagram showing a configuration of a semiconductor integrated circuit according to another embodiment of the present invention;

FIG. 5 is a diagram illustrating a method of causing an electronic device such as a car navigation system, having built the semiconductor integrated circuit corresponding to a system LSI shown in FIG. 4 therein to share a master key with other electronic devices mountable in a vehicle;

FIG. 6 is a diagram showing a configuration of a semiconductor integrated circuit according to a further embodiment of the present invention; and

FIG. 7 is a diagram showing a method of managing an expiration date of a master key (MK) by an electronic device such as a car navigation system, having built the semiconductor integrated circuit corresponding to a system LSI shown in FIG. 6 therein.

### DETAILED DESCRIPTION OF THE PREFERRED EMBODIMENTS

### Typical Embodiments

A summary of typical embodiments of the invention disclosed in the present application will first be explained. Reference numerals of the accompanying drawings referred to with parentheses in the description of the summary of the typical embodiments only illustrate elements included in the concept of components to which the reference numerals are given.

[1] A typical embodiment of the present invention is of a semiconductor integrated circuit (100) comprising a wireless communication control circuit (116) for performing wireless communication that adopts an encrypted communication, and a processing unit (112) for managing a cipher key for the encrypted communication.

The semiconductor integrated circuit (100) further comprises power line communication circuits (114, 120) for performing data transmission by superimposing communication data on a power supply voltage.

The semiconductor integrated circuit (100) can be operated by the power supply voltage supplied to the power line communication circuits (114, 120) via a power line (122).

The power line communication circuits (114, 120) are couplable to other electronic devices (200A1, 200B1, . . . 200N1) via the power line (122).

The wireless communication control circuit (116) is capable of communicating with the other electronic devices (200A1, 200B1, . . . 200N1) by the wireless communication that adopts the encrypted communication.

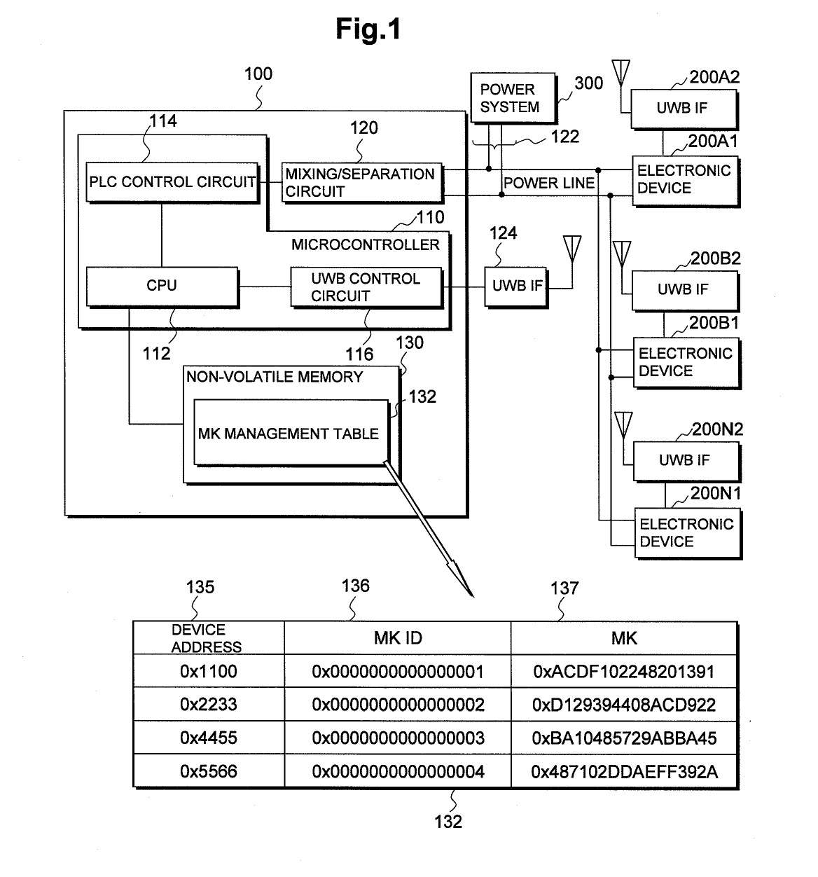

Prior to the execution of the wireless communication adopting the encrypted communication, with the other devices (200A1, 200B1, . . . 200N1) using the wireless communication control circuit (116), the semiconductor integrated circuit (100) is capable of supplying information about the cipher key for the encrypted communication to the other electronic devices (200A1, 200B1, . . . 200N1) via the power line communication circuits (114, 120) (refer to FIG. 1).

According to the embodiment, there can be provided a semiconductor integrated circuit capable of avoiding a needless increase in cable wiring when a cipher key for encrypted communication is shared between other electronic devices upon execution of wireless communication adopting an encrypted communication.

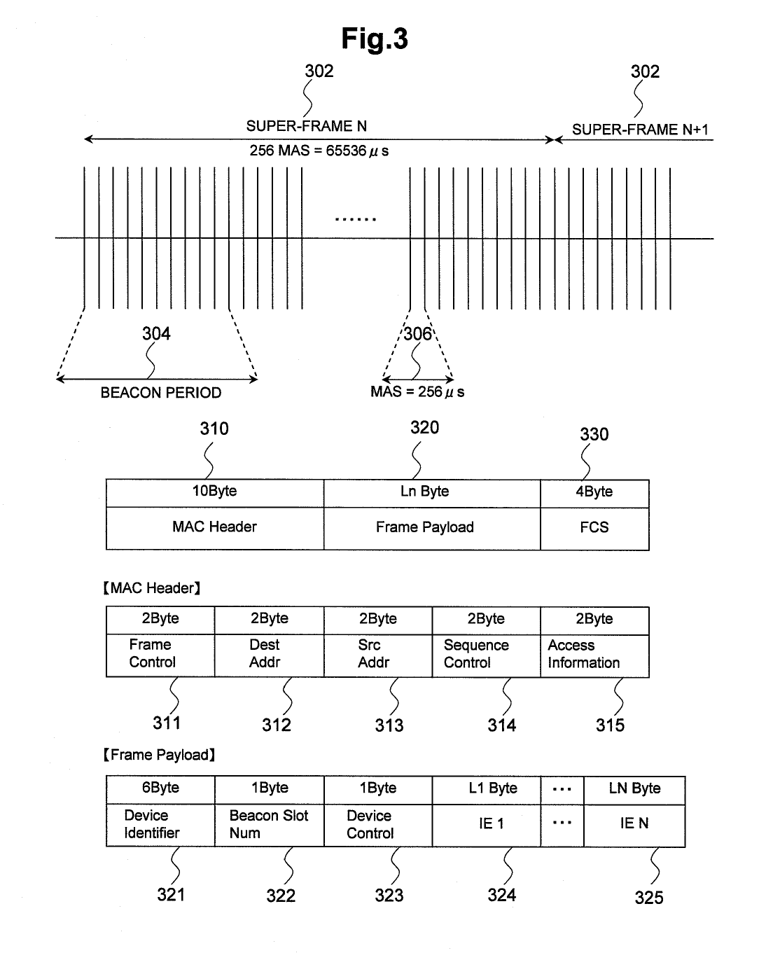

There is provided a preferred embodiment wherein the wireless communication executed by the wireless communication control circuit (116) corresponds to ultra wide band wireless communication using a frequency range of about 3 GHz to about 10 GHz (refer to FIG. 3).

According to the preferred embodiment, wireless communication at a high data transfer rate can be implemented. Wireless communication with a large number of other electronic devices (200A1, 200B1, . . . 200N1) can also be realized.

There is provided another preferred embodiment wherein when the wireless communication that adopts the encrypted communication is performed with the other electronic devices, the semiconductor integrated circuit (100) shares the chipper key with the other electronic devices.

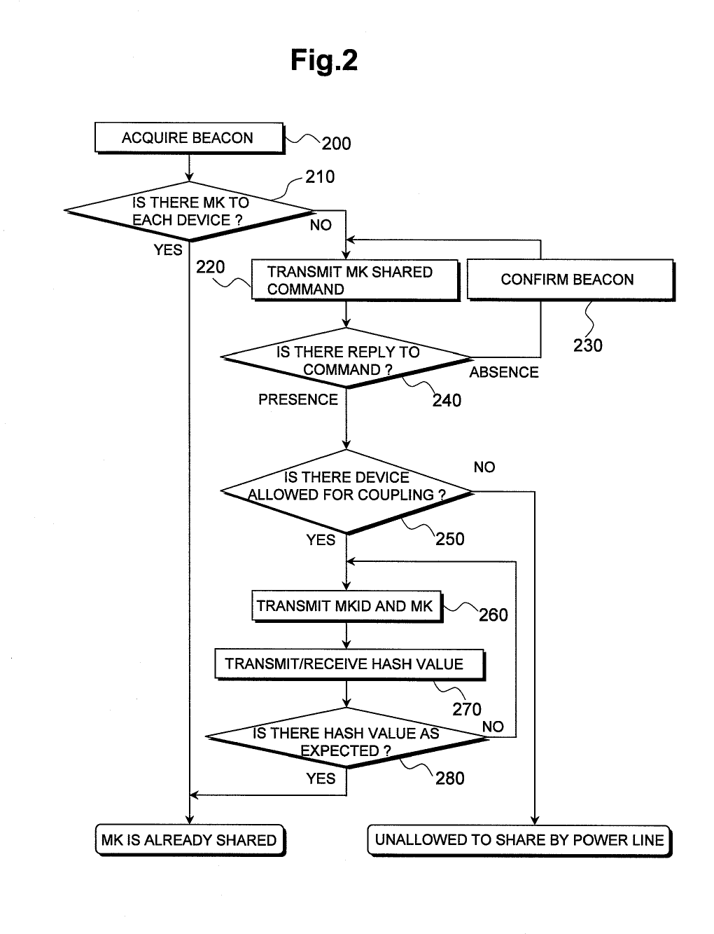

There is provided a further preferred embodiment wherein prior to the sharing of the cipher key between the semiconductor integrated circuit (100) and the other electronic devices, the semiconductor integrated circuit (100) is capable of transmitting a cipher key shared command to the other electronic devices by the wireless communication based on the wireless communication control circuit (116) (refer to FIG. 2).

There is provided yet another preferred embodiment wherein the semiconductor integrated circuit (100) is capable of confirming based on replies to the cipher key shared command from the other electronic devices whether the other electronic devices are of devices of being allowed to share the cipher key (refer to FIG. 2).

There is provided a still further preferred embodiment wherein after it has been confirmed from the replies that the other electronic devices are of the devices being allowed to share the cipher key, the semiconductor integrated circuit (100) is capable of supplying the information about the cipher key to the other electronic devices via the power line communication circuits (114, 120) (refer to FIG. 2).

There is provided a specific embodiment wherein the semiconductor integrated circuit (100) is capable of comparing hash values generated by the other electronic devices from the information about the cipher key supplied to the other electronic devices with hash expected values generated upon the supply of the information to the other electronic devices (refer to FIG. 2).

The semiconductor integrated circuit according to a more specific embodiment further comprises a wired communication circuit (117).

The wired communication circuit (117) can be coupled to another electronic device (200O1) via a wired cable (126).

The wireless communication control circuit (116) is capable of communicating with another electronic device (200O1) by the wireless communication that adopts the encrypted communication.

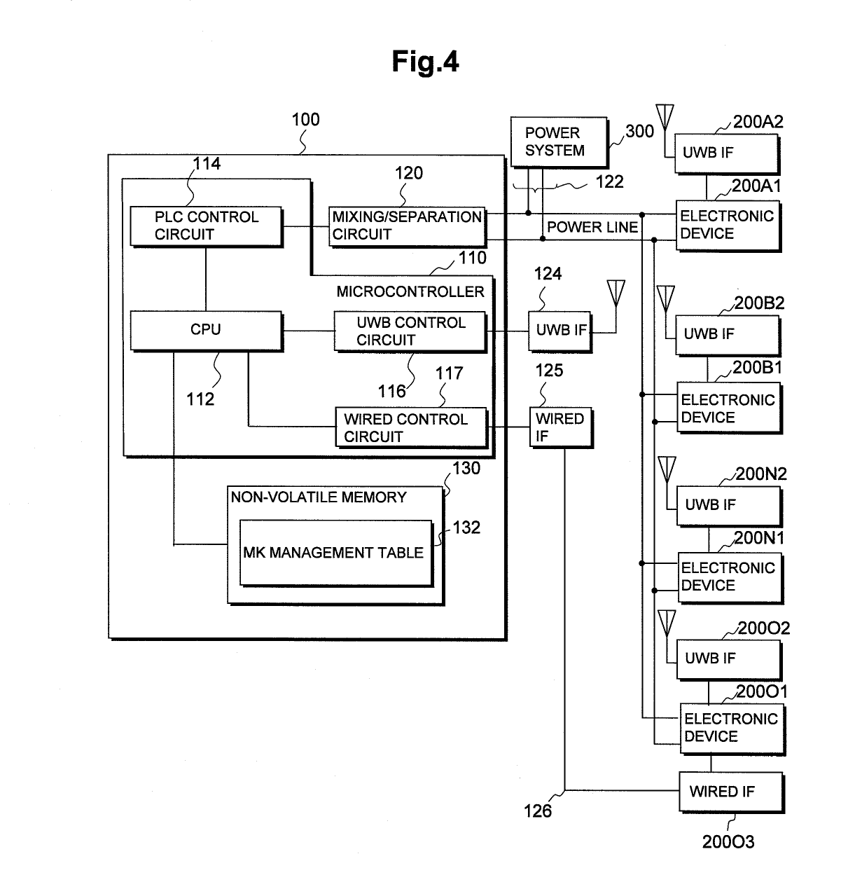

Prior to the execution of the wireless communication adopting the encrypted communication with another electronic device (200O1) using the wireless communication control circuit (116), the semiconductor integrated circuit (100) becomes capable of supplying the information about the cipher key for the encrypted communication to another electronic device (200O1) via the wired communication circuit (117) and the wires cable (126) (refer to FIG. 4).

The semiconductor integrated circuit (100) according to a still more specific embodiment further comprises a non-volatile memory (117).

The non-volatile memory (117) can include a cipher key management table which stores the information about the cipher key for the encrypted communication therein (refer to FIGS. 1, 4 and 6).

There is provided another more specific embodiment wherein the cipher key is a shared key for allowing a mutual authentication between the semiconductor integrated circuit (100) and the other electronic devices.

There is provided a still more specific embodiment wherein the information about the cipher key suppliable to the other electronic devices comprises a master key identifier (136) and a masker key (137) corresponding to a device address (135) for each of the other electronic devices.

The semiconductor integrated circuit (100) according to the most concrete embodiment can be built in a car navigation system mounted in a vehicle (refer to FIGS. 1, 4 and 6).

### <<Description of Embodiments>>

Preferred embodiments will next be described in further detail. In all drawings for describing the best modes for carrying out the invention, components having the same functions as in the above drawings are respectively identified by like reference numerals, and their repetitive explanations will therefore be omitted.

### <<Configuration of Semiconductor Integrated Circuit>>

FIG. 1 is a diagram showing a configuration of a semiconductor integrated circuit according to one embodiment of the present invention.

A semiconductor integrated circuit 100 corresponding to a system LSI mountable in a vehicle is coupled to an ultra wide band wireless interface (UWBIF) 124 to perform ultra wide band (UWB) wireless communication with other external electronic devices 200A1, 200B1, . . . 200N1 each mounted in the vehicle. Ultra wide band wireless interfaces (UWBIFs) 200A2, 200B2, . . . 200N2 are respectively coupled to other external electronic devices 200A1, 200B1, . . . 200N1. The semiconductor integrated circuit 100 is of a general-purpose microcomputer mounted in, for example, a car navigation system. As mentioned in the opening sentence, the semiconductor integrated circuit 100 performs ultra wide band (UWB) wireless communication with a plurality of speakers, a plurality of indication displays, a back camera and a USB slot and the like mounted in the vehicle via the UWBIF 124. The speakers respectively have UWB wireless communication interfaces and power amplifiers built therein. The speakers, indication displays, back camera and USB slot are configured by the external electronic devices 200A1, 200B1, . . . 200N1, which are able to perform UWB wireless communication with the ultra wide band wireless interface (UWBIF) 124 of the car navigation system having built the semiconductor integrated circuit 100 therein via the ultra wide band wireless interfaces (UWBIFs) 200A2, 200B2, . . . 200N2.

The semiconductor integrated circuit 100 is couplable to a power line 122 for power line communication (PLC) to share a master key used upon encryption of the UWB communication. An operating supply voltage from an in-vehicle power system 300 such as a battery and an electric generator or the like mounted in the vehicle can be supplied to the semiconductor integrated circuit 100 built in the car navigation system via the power line 122 and supplied even to the external electronic devices 200A1, 200B1, . . . 200N1 that configure the speakers, indication displays, back camera and USB slot mounted in the vehicle.

Thus, the UWB wireless communication interface and power amplifier built in each speaker are operated by the operating supply voltage supplied from the power line 122. Hence, a UWB wireless signal such as the music from the car navigation system is received by the UWB wireless communication interface built in the speaker and amplified by the speaker built-in power amplifier, followed by being reproduced by the speaker.

Further, the sharing of a master key for the encryption of UWB communication from the car navigation system to its corresponding speaker is executed using the power line communication (PLC) based on the power line 122. Upon the sharing of a master key used not only for the encryption of the UWB communication with the speaker but also for the encryption of the UWB communication with the indication displays, back camera and USB slot or the like, the power line communication (PLC) based on the power line 122 is utilized.

The semiconductor integrated circuit 100 shown in FIG. 1 comprises a microcomputer 110, a mixing/separation circuit 120 for the power line communication (PLC), and a non-volatile memory 130. The microcomputer 110 includes a central processing unit (CPU) 112, a PLC control circuit 114 and a UWB control circuit 116. The CPU 112 is capable of executing various processes as a general-purpose microcomputer for the car navigation system in accordance with various stored programs of the non-volatile memory 130 and controls the PLC control circuit 114 and the UWB control circuit 116.

The UWB control circuit 116 executes ultra wide band (UWB) communication defined in the international standard via the ultra wide band wireless interface (UWBIF) 124 in response to a request for the UWB communication from the CPU 112. The UWB communication signal has been encrypted in accordance with the international standard. Thus, crosstalk at the UWB communication between a plurality of vehicles adjacent to one another can be prevented upon the UWB communication from, for example, the car navigation system to various in-vehicle electronic devices such as speakers or the like.

In response to a request for the power line communication (PLC) from the CPU 112, the PLC control circuit 114 performs transmission/reception of data at shared processing of a master key used upon encryption at the UWB communication with the various in-vehicle electronic devices via the mixing/separation circuit 120 and the power line 122. During the data transmission operation, the mixing/separation circuit 120 executes a mixing process for superimposing transmit data on the operating supply voltage supplied from the in-vehicle power system 300 via the power line 122, whereas during the data reception operation, the mixing/separation circuit 120 performs a separation process for extracting receive data superimposed on the operating supply voltage supplied from the in-vehicle power system 300 via the power line 122.

The non-volatile memory 130 is of a semiconductor non-volatile memory like an electrically erasable and programmable read only memory (EEPROM), a flash memory or the like. The non-volatile memory 130 includes a mask key (MK) management table 132 managed by the CPU 112 of the microcontroller 110. The master key (MK) management table 132 comprises a plurality of entries which store device addresses 135, master key identifiers (MKIDs) 136 and master keys (MK) 137 therein.

The device address 135 is of an address for uniquely determining each electronic device that performs UWB communication. A data length of this address is defined as 2 bytes in accordance with the international standard. The master key identifier (MKID) 136 is an identifier (ID) for uniquely determining a master key (MK) 137. A data length of the identifier (ID) is defined as 16 bytes in accordance with the international standard. A data length of the last master key (MK) 137 is defined as 16 bytes in accordance with the international standard.

As mentioned in the opening sentence, it is necessary to share a master key between two devices for the purpose of establishing new pair-wise temporal keys (PTKs) between the two devices by the four-way handshake for the encrypted communication at the UWB communication based on the international standard and thereby authenticating the identity of the two devices.

### <<Sharing Method of Master Key>>

FIG. 2 is a diagram showing a method for causing each electronic device such as the car navigation system having built the semiconductor integrated circuit 100 corresponding to the system LSI shown in FIG. 1 therein to share a master key (MK) with each of other electronic devices each mountable in the vehicle.

At Step 200 of FIG. 2, the semiconductor integrated circuit 100 acquires a Beacon transmitted from the other electronic device by broadcast. In the UWB communication based on the international standard, an unused frequency band and an unused frequency hopping pattern are detected by carrier sensing to avoid collisions. Thereafter, the detection of a beacon period and the detection of an unused beacon slot subsequent to its detection are carried out. Thus, the various electronic devices that exist in a UWB communication range transmit beacons to declare their own existence. Incidentally, since the sharing of the master key (MK) is not necessary when no beacon is transmitted at Step 200, a master key (MK) sharing sequence is completed.

The semiconductor integrated circuit 100 confirms at Step 210 whether the master key identifier (MKID) 136 and the master key (MK) 137 corresponding to the other electronic device having transmitted the beacon at Step 200 of FIG. 2 exist in the master key (MK) management table 132. Incidentally, a device address 135 for each of the other electronic devices is contained in the beacon transmitted by the other electronic device at Step 200.

When the master key identifier (MKID) 136 and the master key (MK) 137 corresponding to the other electronic device having transmitted the beacon at Step 200 exist in the master key (MK) management table 132 by the confirmation at Step 210, it is determined that the electronic device with the semiconductor integrated circuit 100 built therein and each of the other electronic devices share the master key (MK).

When the master key identifier (MKID) 136 and the master key (MK) 137 corresponding to the other electronic device having transmitted the beacon at Step 200 do not exist in the master key (MK) management table 132 by the confirmation at Step 210, it is determined that the electronic device with the semiconductor integrated circuit 100 built therein and the other electronic device do not share the master key (MK) therebetween. In this case, the electronic device with the semiconductor integrated circuit 100 built therein transmit a master key (MK) shared command to the other electronic device having transmitted the beacon at Step 200 of FIG. 2 through the ultra wide band wireless interface (UWBIF) 124 at Step 220. Incidentally, in the present embodiment, either one of the two devices and the other thereof can be designated as a master device and a slave device respectively when the master key (MK) is shared by the master key (MK) shared command. By comparing the values of device addresses 135 of the two devices, one thereof large in address value and one thereof small in address value can also be respectively set as the master device and the slave device in another embodiment.

After the master key (MK) shared command has been transmitted at Step 220, the electronic device with the semiconductor integrated circuit 100 built therein waits for a reply from the other electronic device corresponding to the master key (MK) shared command at Step 240. In doing so, the other electronic device having transmitted the beacon at Step 200 receives the master key (MK) shared command, generates a reply to the received master key (MK) shared command and transmits the reply to the electronic device with the semiconductor integrated circuit 100 built therein. When no reply is issued even after a few ms have elapsed since the transmission of the command, it is confirmed at Step 230 whether the beacon is being transmitted from each of other electronic devices, and thereafter a master key (MK) shared command is retransmitted at Step 220.

When there exists a reply from the other electronic device corresponding to the master key (MK) shared command at Step 240, the electronic device having the semiconductor integrated circuit 100 built therein authenticates the answered other electronic device at Step 250 and confirms that it is of the corresponding electronic device allowed to share the master key (MK) therebetween. This authentication is enabled by the utilization of a signed certificate of certificate authority (CA) as well known.

When it is determined at Step 250 that the other electronic device is of the electronic device unallowed to share th master key (MK), the electronic device having the semiconductor integrated circuit 100 built therein terminates the master key (MK) sharing sequence.

When it is determined at Step 250 that the other electronic device is of the electronic device allowed to share the master key (MK) therebetween, the electronic device with the semiconductor integrated circuit 100 built therein transmits a master key identifier (MKID) 136 and a master key (MK) 137 to each of the other electronic devices via the power line 122 at next Step 260. Each of the master key identifier (MKID) 136 and the master key (MK) 137 assumes a data format of a Header, a Frame Payload and a Frame Check Sequence (FCS). A transmission source address and a transmission destination address are contained in the Header. When one master key identifier (MKID) 136 and one master key (MK) 137 are respectively divided into a plurality of frames and individually transmitted for the reason that the storage capacity of a data transmission buffer of the semiconductor integrated circuit 100 is small, for example, a frame sequence number is contained in the data format. The Frame Payload includes data of the master key identifier (MKID) 136 and data of the master key (MK) 137.

The other electronic device having received the master key identifier (MKID) 136 and the master key (MK) 137 from the electronic device having built the semiconductor integrated circuit 100 therein via the power line 122 generates a fixed-length hash value from the received data and transmits it to the electronic device having built the semiconductor integrated circuit 100 therein via the power line 122 at Step 270. Thus, at Step 270, the electronic device with the semiconductor integrated circuit 100 built therein receives the hash value transmitted from the other electronic device via the power line 122.

As well known, a sequence of a character string of documents, numerals, etc. is transformed into fixed-length hash values by a hash function. Upon transmission/reception of data via a communication line, hash values of data are calculated at both ends of a path and both are compared with each other, thereby making it possible to examine whether the data is falsified or changed in the course of communications. The most used hash functions are SHA-1 (Secure Hash Algorithm One) and MD5 (Message Digest Algorithm Five).

On the other hand, after the electronic device with the semiconductor integrated circuit 100 built therein has transmitted the master key identifier (MKID) 136 and the master key (MK) 137 to each of the other electronic devices via the power line 122 at Step 260, such an electronic device generates an expected value of a fixed-length hash value from transmitted data. Thus, the electronic device having built the semiconductor integrated circuit 100 therein receives the hash value transmitted from the other electronic device at Step 270, and thereafter compares, at next Step 280, the hash value received at Step 270 with the expected value of the hash value generated upon data transmission at Step 260. When the received hash value coincides with the expected value, the electronic device having built the semiconductor integrated circuit 100 therein determines that the master key (MK) 137 is shared with the other electronic device. When they do not coincide with each other, the electronic device with the semiconductor integrated circuit 100 built therein retransmits a master key identifier (MKID) 136 and a master key (MK) 137 to each of the other electronic devices via the power line 122 at Step 260. Incidentally, a method for generating the hash values by the other electronic device and the electronic device with the semiconductor integrated circuit 100 built therein calculates their other hash values in accordance with the master key identifier (MKID) 136 and the master key (MK) 137.

### <<UWB Communication>>

FIG. 3 is a diagram for describing mutual communications between two devices at the UWB communication defined in the international standard.

Namely, a basic timing structure for performing a frame exchange, which is called “super-frame”, has been defined at the UWB communication defined in the international standard. The super-frame comprises 256 medium access slots (MAS) 306. A time length of one media access slot (MAS) 306 is 256 μS. The media access slots (MAS) 306 are time slots allocated for every electronic device.

A first several media access slots (MAS) in one super-frame are allocated as a beacon period 304. During the beacon period 304, each of the electronic devices transmits a beacon by broadcast. With the transmission of the beacon, each electronic device declares its own existence in a UWB communication range.

In a manner similar to other media access slot (MAS) data, the beacon comprises a Media Access Control Header (MAC Header) 310 of 10 bytes, a Frame Payload 320 and a Frame Check Sequence (FCS) 330 of 4 bytes.

The 10-btye media access control header (MAC Header) 310 comprises a Frame Control 311 (2 bytes), a Destination Address (Dest Addr) 312 (2 bytes), a Source Address (Src Addr) 313 (2 bytes), a Sequence Control 314 (2 bytes) and an Access information 315 (2 bytes). In the case of the beacon, the value set to each element is defined based on the international standard.

The Frame Payload 320 comprises a Device Identifier 321 (6 bytes), a Beacon Slot Num 322 (1 byte), a Device Control 323 (1 byte), a plurality of Information Elements (IEs) 324 and 325. The values set to the Device Identifier 321, the Beacon Slot Num 322 and the Device Control 323 are defined based on the international standard.

Various information can be set to the Information Elements (IEs) 324 and 325. It is possible to set, for example, an address of each couplable electronic device, the time length of the beacon period 304, each channel used in communications. Further, independent information can also be set for every application.

### <<Addition of Wired Interface>>

FIG. 4 is a diagram showing a configuration of a semiconductor integrated circuit according to another embodiment of the present invention.

As compared with the semiconductor integrated circuit 100 shown in FIG. 1, the present semiconductor integrated circuit is different therefrom in that a wired control circuit 117 is added to a microcontroller 110 of the semiconductor integrated circuit 100 corresponding to a system LSI mountable in a vehicle, which is shown in FIG. 4, and an external wired interface 125 is coupled to the wired control circuit 117. The present semiconductor integrated circuit is the same as that shown in FIG. 1 in other respects.

In FIG. 4, another electronic device 200O1 is added with respect to the in-vehicle electronic devices 200A1, 200B1, . . . 200N1 shown in FIG. 1. In FIG. 4, an ultra wide band wireless interface (UWBIF) 200O2 and a wired interface 200O3 are further added with respect to the in-vehicle ultra wide band wireless interfaces (UWBIFs) 200A2, 200B2, . . . 200N2 shown in FIG. 1. The other electronic device 200O1 added in FIG. 4 is of, for example, a USB slot. The USB slot is couplable via a USB cable to a cellular phone terminal and a portable electronic device brought in the vehicle. The electronic device 200O1 corresponding to the USB slot can be supplied with an operating supply voltage from an in-vehicle power system 300 via a power line 200. On the other hand, the electronic device 200O1 is able to perform UWB wireless communication with its corresponding ultra wide band wireless interface (UWBIF) 124 of a car navigation system with the semiconductor integrated circuit 100 built therein via the ultra wide band wireless interface (UWBIF) 200O2. As a result, the music of a non-volatile memory built in the cellular phone terminal, the portable electronic device or the like is transferred from the electronic device 200O1 corresponding to the USB slot to the semiconductor integrated circuit 100 built in the car navigation system via the ultra wide band wireless interfaces (UWBIFs) 200O2 and 124. The music transferred to the semiconductor integrated circuit 100 built in the car navigation system can be reproduced from any one of in-vehicle speakers in the external electronic devices 200A1, 200B1, . . . 200N1 through the ultra wide band wireless interfaces (UWBIFs) 124, 200A2, 200B2, . . . 200N2.

In order to share the master key used upon encryption of the UWB communication with the electronic device 200O1 corresponding to the USB slot, the semiconductor integrated circuit 100 is made couplable to a wired cable 126. Namely, the wired control circuit 117 of the microcontroller 110 in the semiconductor integrated circuit 100 is coupled to the wired cable 126 via the external wired interface 125.

When the master key (MK) is shared for the electronic device 200O1 corresponding to the USB slot, its sharing is done via the wired cable 126 without via the power line 122 in the embodiment of FIG. 4 unlike the embodiment shown in FIG. 1. The respective Steps of FIG. 2 taken in the method for sharing the masker key (MK) where the wired cable 126 is used are changed as follows:

At change Step 200 where the wired cable 126 is used, a beacon transmitted from the ultra wide band wireless interface (UWBIF) 200O2 coupled to the electronic device 200O1 corresponding to the USB slot is acquired by the ultra wide band wireless interface (UWBIF) 124 coupled to the semiconductor integrated circuit 100 built in the car navigation system.

At next change Step 210, the semiconductor integrated circuit 100 confirms whether a master key identifier (MKID) 136 and a master key (MK) 137 corresponding to the electronic device 200O1 being the USB slot corresponding to the UWBIF 200O2 having transmitted the beacon at change Step 200 exist in a master key (MK) management table 132. Incidentally, the beacon transmitted by the UWBIF 200O2 at change Step 200 contains a device address 135 for the electronic device 200O1 corresponding to the USB slot.

When the master key identifier (MKID) 136 and the master key (MK) 137 corresponding to the electronic device 200O1 being the USB slot coupled to the UWBIF 200O2 having transmitted the beacon at change Step 200 exist in the master key (MK) management table 132 by the confirmation at change Step 210, it is determined that the electronic device with the semiconductor integrated circuit 100 built therein and its corresponding other electronic device are sharing the master key (MK).

When the master key identifier (MKID) 136 and the master key (MK) 137 corresponding to the electronic device 200O1 being the USB slot coupled to the UWBIF 200O2 having transmitted the beacon at change Step 200 do not exist in the master key (MK) management table 132 by the confirmation at change Step 210, it is determined that the electronic device with the semiconductor integrated circuit 100 built therein and the other electronic device are not sharing the master key (MK). In this case, the electronic device with the semiconductor integrated circuit 100 built therein transmits a master key (MK) shared command to the UWBIF 200O2 coupled to the electronic device 200O1 being the USB slot via the ultra wide band wireless interface (UWBIF) 124 at change Step 220.

After the master key (MK) shared command has been transmitted at change Step 220, the electronic device with the semiconductor integrated circuit 100 built therein waits for a reply from the other electronic device corresponding to the master key (MK) shared command at change Step 240. In doing so, the electronic device 200O1 corresponding to the USB slot coupled to the UWBIF 200O2 having transmitted the beacon at change Step 200 receives the master key (MK) shared command, generates a reply to the received master key (MK) shared command and transmits the reply to the electronic device with the semiconductor integrated circuit 100 built therein. When no reply is done even after a few ms have elapsed since the transmission of the command, it is confirmed at change Step 230 whether the beacon is being transmitted from each of other electronic devices, and thereafter a master key (MK) shared command is retransmitted at change Step 220.

When there exists a reply from the electronic device 200O1 being the USB slot, corresponding to the master key (MK) shared command at change Step 240, the electronic device having built the semiconductor integrated circuit 100 therein authenticates the answered electronic device 200O1 at change Step 250 and confirms that it is of the corresponding electronic device allowed to share the master key (MK) therebetween. This authentication is enabled by the utilization of a signed certificate of certificate authority (CA).

When it is determined at change Step 250 that the electronic device 200O1 is of the electronic device unallowed to share th master key (MK), the electronic device having the semiconductor integrated circuit 100 built therein terminates a master key (MK) sharing sequence.

When it is determined at change Step 250 that the electronic device 200O1 is of the electronic device allowed to share the master key (MK), the electronic device with the semiconductor integrated circuit 100 built therein transmits a master key identifier (MKID) 136 and a master key (MK) 137 to the electronic devices 200O1 via the wired cable 126 at next change Step 260.

The electronic device 200O1 being the USB slot having received the master key identifier (MKID) 136 and the master key (MK) 137 from the electronic device having built the semiconductor integrated circuit 100 therein via the wired cable 126 generates a fixed-length hash value from the received data and transmits it to the electronic device having built the semiconductor integrated circuit 100 therein via the wired cable 126 at change Step 270. Thus, at change Step 270, the electronic device with the semiconductor integrated circuit 100 built therein receives the hash value transmitted from its corresponding other electronic device via the wired cable 126.

On the other hand, after the electronic device with the semiconductor integrated circuit 100 built therein has transmitted the master key identifier (MKID) 136 and the master key (MK) 137 to the electronic device 200O1 via the wired cable 126 at change Step 260, such an electronic device generates an expected value of a fixed-length hash value from the transmitted data. Thus, the electronic device having built the semiconductor integrated circuit 100 therein receives the hash value transmitted from the electronic device 200O1 at change Step 270 and thereafter compares the hash value received at change Step 270 with the expected value of the hash value generated upon data transmission at Step 260 at next change Step 280. When the received hash value coincides with the expected value, the electronic device having built the semiconductor integrated circuit 100 therein determines that the master key (MK) 137 has been shared with the electronic device 200O1. When they do not coincide with each other, the electronic device with the semiconductor integrated circuit 100 built therein retransmits a master key identifier (MKID) 136 and a master key (MK) 137 to the electronic device 200O1 via the wired cable 126 at change Step 260.

### <<Sharing of Master Key by Power Line Communication and Wired Interface>>

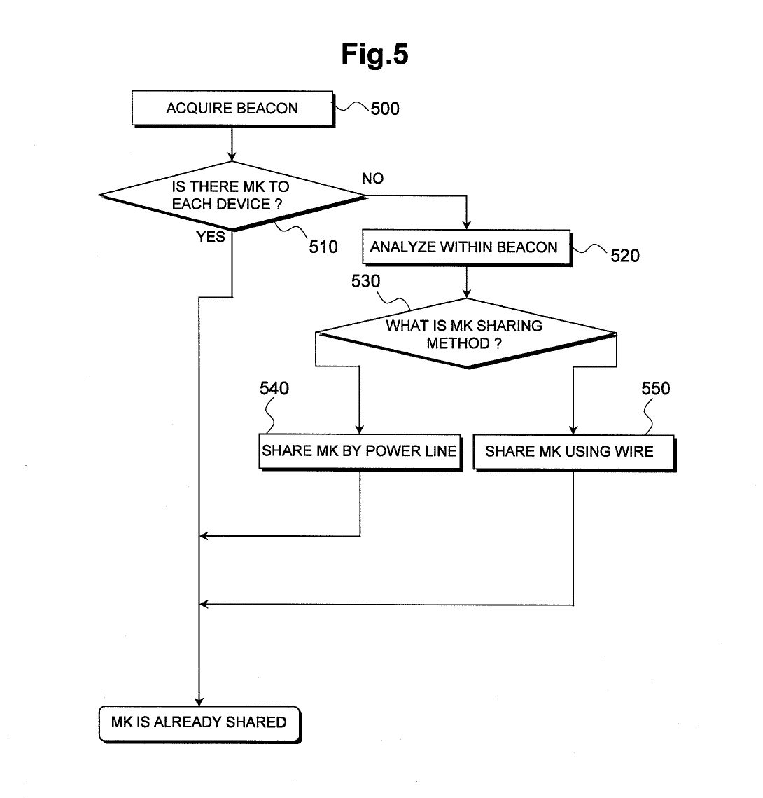

FIG. 5 is a diagram showing a method for causing an electronic device such as a car navigation system, having built the semiconductor integrated circuit 100 corresponding to the system LSI shown in FIG. 4 therein to share a master key (MK) with each of other electronic devices.

At Step 500 of FIG. 5, the semiconductor integrated circuit 100 acquires a beacon transmitted by broadcast from the other electronic device. In so doing, a beacon analysis module lying inside a CPU 112 of the semiconductor integrated circuit 100 confirms the presence or absence of a master key identifier (MKID) 136 and a master key (MK) 137 corresponding to the electronic device corresponding to a beacon transmission source from the management table 132 of the non-volatile memory 130 at Step 510.

When the master key identifier (MKIFD) 136 and the master key (MK) 137 corresponding to the electronic device of the beacon transmission source exist in the management table 132, the beacon analysis module of the CPU 112 notifies other modules 114, 116, 117 and 120 lying inside the semiconductor integrated circuit 100 of having been already performed of sharing of the master key (MK). In a preferred embodiment, the supply of operating power (operating supply voltage) to the PLC control circuit 114 and the wired control circuit 117 is stopped by this notification, so that unnecessary power consumption of the semiconductor integrated circuit 100 is reduced. Utilizing the already-shared master key (MK), the semiconductor integrated circuit 100 performs UWB communication with the ultra wide band wireless interfaces (UWBIFs) 124, 200A2, 200B2, . . . 200O2 coupled to the external electronic devices 200A1, 200B1, . . . 200O1 via the ultra wide band wireless interface (UWBIF) 124.

When, however, the master key identifier (MKID) 136 and the master key (MK) 137 corresponding to the electronic device of the beacon transmission source do not exist in the management table 132, the beacon analysis module of the CPU 112 analyzes a Payload part of the beacon at Step 520. For example, the information elements (IEs) 324 and 325 of the Frame Payload 320 of the beacon described in FIG. 3 contain information descriptive of the master key (MK) sharing method. Thus, at Step 530, the beacon analysis module of the CPU 112 can acquire the information about the master key (MK) sharing method from the result of analysis of the Payload part at Step 520.

When the sharing method of the master key (MK) is found to correspond to the power line communication as a result of analysis of the Payload part of the beacon, the sharing of the master key (MK) by the power line communication is executed at Step 540 of FIG. 5. The execution of the sharing of the master key (MK) by the power line communication at Step 540 complies with the procedure from Steps 220 to 280 of the master key (MK) sharing method described in FIG. 2. In a preferred embodiment, the supply of the operating power (operating supply voltage) to the wired control circuit 117 is stopped during this period, so that unnecessary power consumption of the semiconductor integrated circuit 100 is reduced.

When the sharing method of the master key (MK) is found to be a wired interface as a result of analysis of the Payload part of the beacon, the sharing of the master key (MK) by the wired interface is executed at Step 550 of FIG. 5. The execution of the sharing of the master key (MK) by the wired interface at Step 550 complies with the procedure from change Steps 220 to 280 of the master key (MK) sharing method described in FIG. 4. In a preferred embodiment, the supply of the operating power (operating supply voltage) to the PLC control circuit 114 is stopped during this period, so that unnecessary power consumption of the semiconductor integrated circuit 100 is reduced.

### <<Timer>>

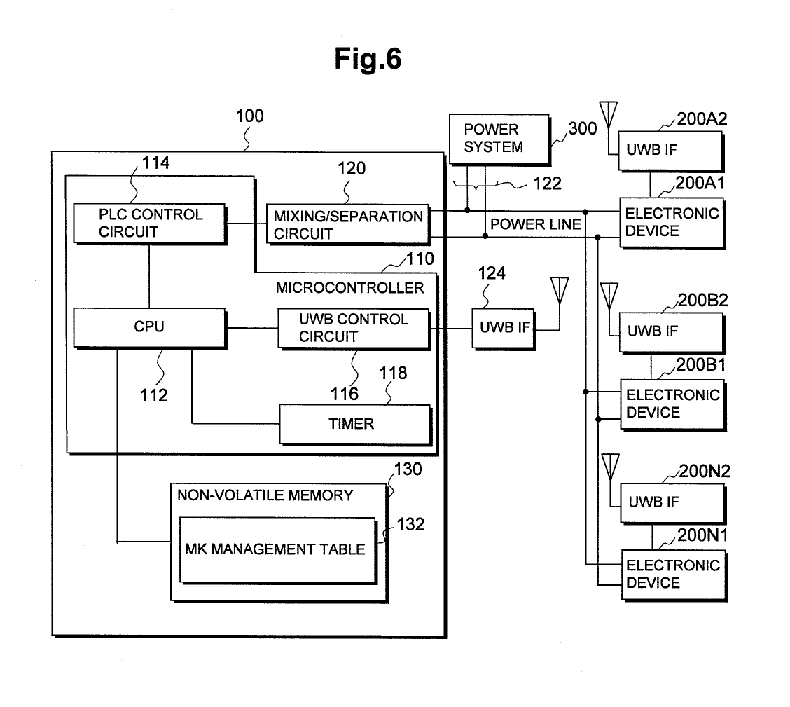

FIG. 6 is a diagram showing a configuration of a semiconductor integrated circuit according a further embodiment of the present invention.

As compared with the semiconductor integrated circuit 100 shown in FIG. 1, the present semiconductor integrated circuit is different therefrom in that a timer 118 is added to a CPU 112 of a microcontroller 110 of the semiconductor integrated circuit 100 corresponding to a system LSI mountable in a vehicle, which is shown in FIG. 6, and the timer 118 controls an expiration date in relation to the utilization of a master key (MK). The present semiconductor integrated circuit is the same as that shown in FIG. 1 in other respects.

The timer 118 can perform access from other modules such as the CPU 112, PLC control circuit 114, etc. and has the function of measuring an arbitrary time.

### <<Management of Expiry Date of Master Key>>

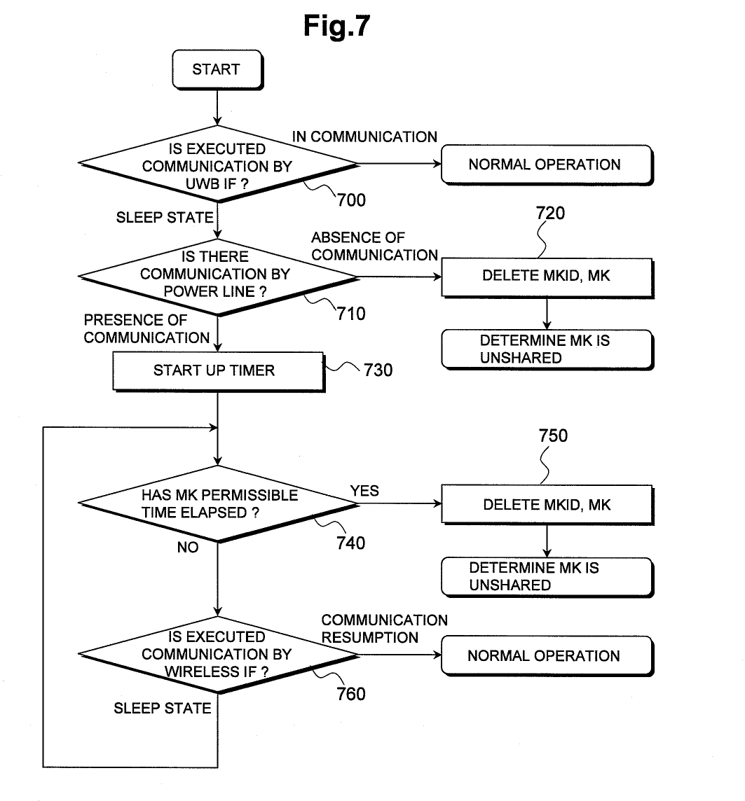

FIG. 7 is a diagram showing a method of managing an expiration date of a master key (MK) by an electronic device such as a car navigation system, having built the semiconductor integrated circuit 100 corresponding to the system LSI shown in FIG. 6 therein.

At Step 700, the semiconductor integrated circuit 100 shown in FIG. 6 determines whether UWB wireless communication using an ultra wide band wireless interface are being executed. When the semiconductor integrated circuit 100 determines that the UWB wireless communication is in execution, it is determined that it is in an normal operation. Information (maser key identifier (MKID) 136 and master key (MK) 137 corresponding to device address 135) about a master key (MK) shared at that time is stored in a master key management table 132 of a non-volatile memory 130.

When it is however determined at Step 700 that the UWB wireless communication is in a sleep state or non-executed state, the semiconductor integrated circuit 100 transmits a master key (MK) management command to other electronic devices 200A1, 200B1, . . . 200N1 via a power line 122 at Step 710.

When there is no reply from each of other electronic devices 200A1, 200B1, . . . 200N1 with respect to the master key (MK) management command transmitted at Step 710, the semiconductor integrated circuit 100 deletes the corresponding information (master key identifier (MKID) 136 and master key (MK) 137 corresponding to device address 135) about the master key (MK) being stored in the master key (MK) management table 132 of the non-volatile memory 130 at that time at Step 720 and brings the master key (MK) to a non-shared state.

When there is a reply from each of other electronic devices 200A1, 200B1, . . . 200N1 with respect to the master key (MK) management command transmitted at Step 710, the semiconductor integrated circuit 100 starts up the timer 118 at Step 730.

After the startup of the timer 118 at Step 730, the semiconductor integrated circuit 100 determines at Step 740 whether some reply is given during a predetermined permissible time.

When there is no any kind of reply during the predetermined permissible time at Step 740, the semiconductor integrated circuit 100 deletes the corresponding information (master key identifier (MKID) 136 and master key (MK) 137 corresponding to device address 135) about the master key (MK) being stored in the master key (MK) management table 132 of the non-volatile memory 130 at that time at Step 750 and brings the master key (MK) to a non-shared state.

When the semiconductor integrated circuit 100 detects at Step 760 that the UWB wireless communication using the ultra wide band wireless interface (UWBIF) 124 has been resumed before the elapse of the predetermine permissible time at Step 740, it is determined to be normal in operation, and information (maser key identifier (MKID) 136 and master key (MK) 137 corresponding to device address 135) about a master key (MK) being shared at that time is stored in the maser key management table 132. Incidentally, when the UWB wireless communication is determined to be in the sleep state before the elapse of the predetermined permissible time at Step 740, the processing is returned to Step 740.

The information about the master key (MK) of each electronic device placed in an unused state over a relatively long period can be arranged inside the master key (MK) management table 132.

While the invention made above by the present inventors has been described specifically on the basis of the embodiments, the present invention is not limited to the embodiments. It is needless to say that various changes can be made thereto within the scope not departing from the gist thereof.

For example, the PLC control circuit 114 and the UWB control circuit 116 can also be configured as some internal modules of the CPU 112. Even in this case, however, the supply of the operating supply voltage for operating the respective control circuits of the PLC control circuit 114 and the UWB control circuit 116 may preferably be independent of the supply of the operating supply voltage for operating the CPU 112. Consequently, power consumption of the semiconductor integrated circuit 100 can be reduced by executing power management for controlling the supply of the operating supply voltage according to the state of operation of each internal module.

As another method for calculating hash values at Steps 160 and 270 of the master key sharing method shown in FIG. 2, there can also be adopted a method for combining data about a master key identifier (MKID) 136 and a master key (MK) 137 and calculating hash values of a string of the combined data. Further, each of the hash values calculated by other electronic devices can also be transmitted to the electronic device having built the semiconductor integrated circuit 100 therein not through the power line 122 but through the ultra wide band wireless interface (UWBIF). Upon doing so, the hash values transmitted via the ultra wide band wireless interface (UWBIF) have no problem even if they remain at raw data without being encrypted. This is because each hash value is of a one-way cipher which cannot be inverse-transformed into raw data of a character string of documents, numerals, etc.

Further, the embodiment described in FIGS. 4 and 5 has explained the method of selecting the master key (MK) sharing method by any one of the power line communication and the wired interface, utilizing the Payload part of the beacon. The present invention is however not limited to this selecting method. The master key (MK) sharing method can also be selected by utilizing the device address 135. There is provided, for example, a method for performing the sharing of the master key (MK) by the power line communication using the power line 122 as to each device address stored in advance in the master key (MK) management table 132 of the non-volatile memory 130 and for performing the sharing of the master key (MK) by the wired interface using the wired interface 124 as to each device address unstored in advance in the master key (MK) management table 132.

In the embodiment described in FIGS. 6 and 7, the timing provided to start up the timer 118 can also be set when the in-vehicle power system 300 is switched from an operation mode by an electric generator coupled to an automotive engine to an operation mode by a battery alone, irrespective of the presence or absence of the execution of the UWB wireless communication.

Namely, the operating supply voltage supplied via the power line 122 is lowered than at the normal time depending on the operation mode by only the battery of the in-vehicle power system 300. Thus, the operations of the car navigation system with the semiconductor integrated circuit 100 built therein and other electronic devices 200A1, 200B1, . . . 200N1 also become uncertain. Further, the operations of the ultra wide band wireless interfaces 124, 200A2, 200B2, . . . 200N2 also become uncertain.

As a result, the UWB wireless communication is also made impossible. Therefore, in such a case, the semiconductor integrated circuit 100 deletes information (master key identifier (MKID) 136 and master key (MK) 137 corresponding to each device address 135) about each master key (MK) stored at that time in the master key (MK) management table 132 of the non-volatile memory 130 at Step 750 after the elapse of the predetermined time at Step 740 and brings the master key (MK) to the non-shared state. Since the operations of the wired interfaces 125, 200O3 of the embodiment described in FIGS. 4 and 5 also become uncertain in such a case, the information about the master key (MK) whose sharing has been started by the wired interface at Step 550 of the processing shown in FIG. 5 can also be deleted after the predetermined time has elapsed.

Although the method using the certificate of the certificate authority (CA) has been explained as the method for authenticating other electronic devices at Step 250 of the master key sharing method shown in FIG. 2, the present invention is not limited to this authentication method. For example, attribute information about other electronic devices are displayed on the indication display lying in front of the driver's seat of the car navigation system with the semiconductor integrated circuit 100 built therein, whereby it can also be determined from such attribute information whether other electronic devices are allowed to share the master key.

Further, the data lengths of the device address 135, master key identifier (MKID) 136 and master key (MK) 137 stored in the master key (MK) management table 132 of the non-volatile memory 130 of the semiconductor integrated circuit 100 shown in each of FIGS. 1, 4 and 6 were based on the above international standard. The present invention is however not limited to this, but these data lengths may not be based on the international standard.

Furthermore, the non-volatile memory 130 including the master key (MK) management table 132 that stores the device address 135, master key identifier (MKID) 136 and master key (MK) 137 therein is not limited to the internal non-volatile memory built in the semiconductor integrated circuit 100. Namely, the non-volatile memory 130 including the master key (MK) management table 132 can also be as an external non-volatile memory coupled to the outside of the semiconductor integrated circuit 100.

The electronic device having built the semiconductor integrated circuit 100 shown in each of FIGS. 1, 4 and 6 therein is not limited to the car navigation system mounted in the vehicle, but may be applied widely to such an environment that the UWB wireless communication and the power line communication (PLC) are made possible inside a building like, for example, a SOHO (Small Office/Home Office) or the like.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A semiconductor integrated circuit comprising:
a wireless communication control circuit for performing wireless communication which adopts an encrypted communication; and
a processing unit for managing a cipher key for the encrypted communication,
wherein the semiconductor integrated circuit further comprises a power line communication circuit for performing data transmission by superimposing communication data over a power supply voltage,
wherein the semiconductor integrated circuit is capable of being operated by the power supply voltage supplied externally to the power line communication circuit via a power line,
wherein the power line communication circuit is couplable to other electronic devices via the power line,
wherein the wireless communication control circuit is capable of communicating with the other electronic devices by the wireless communication which adopts the encrypted communication, and
wherein prior to the execution of the wireless communication adopting the encrypted communication, with the other devices using the wireless communication control circuit, the semiconductor integrated circuit is capable of supplying information about the cipher key for the encrypted communication to the other electronic devices via the power line communication circuit.

2. The semiconductor integrated circuit according to claim 1, wherein the wireless communication executed by the wireless communication control circuit is of an ultra wide band wireless communication using a frequency range of about 3 GHz to about 10 GHz.

3. The semiconductor integrated circuit according to claim 2, wherein when the wireless communication which adopts the encrypted communication is performed with the other electronic devices, the semiconductor integrated circuit shares the chipper key with the other electronic devices.

4. The semiconductor integrated circuit according to claim 3, wherein prior to the sharing of the cipher key between the semiconductor integrated circuit and the other electronic devices, the semiconductor integrated circuit becomes capable of transmitting a cipher key shared command to the other electronic devices by the wireless communication based on the wireless communication control circuit.

5. The semiconductor integrated circuit according to claim 4, wherein the semiconductor integrated circuit is capable of confirming based on replies to the cipher key shared command from the other electronic devices whether the other electronic devices are of devices of being allowed to share the cipher key.

6. The semiconductor integrated circuit according to claim 5, wherein after the other electronic devices are confirmed, from the replies, to be devices being allowed to share the cipher key, the semiconductor integrated circuit becomes capable of supplying the information about the cipher key to the other electronic devices via the power line communication circuit.

7. The semiconductor integrated circuit according to claim 6, wherein the semiconductor integrated circuit is capable of comparing hash values generated by the other electronic devices from the information about the cipher key supplied to the other electronic devices with hash expected values generated upon the supply of the information about the cipher key to the other electronic devices.

8. The semiconductor integrated circuit according to claim 7, further comprising a wired communication circuit,
wherein the wired communication circuit is couplable to another electronic device via a wired cable,
wherein the wireless communication control circuit is capable of communicating with the another electronic device by the wireless communication which adopts the encrypted communication, and
wherein prior to the execution of the wireless communication adopting the encrypted communication, with the another electronic device using the wireless communication control circuit, the semiconductor integrated circuit becomes capable of supplying the information about the cipher key for the encrypted communication to the another electronic device via the wired communication circuit and the wires cable.

9. The semiconductor integrated circuit according to claim 7, further comprising a non-volatile memory,
wherein the non-volatile memory is capable of comprising a cipher key management table which stores the information about the cipher key for the encrypted communication therein.

10. The semiconductor integrated circuit according to claim 1, wherein the cipher key is a shared key for allowing a mutual authentication between the semiconductor integrated circuit and the other electronic devices.

11. The semiconductor integrated circuit according to claim 10, wherein the information about the cipher key suppliable to the other electronic devices is a master key identifier and a masker key corresponding to a device address for each of the other electronic devices.

12. The semiconductor integrated circuit according to claim 10, wherein the semiconductor integrated circuit is capable of being built in a car navigation system mounted in a vehicle.
